(19) United States
(12) Patent Application Publication
(10) Pub. No.: US 2026/0158483 A1
(43) Pub. Date: Jun. 11, 2026

(54) METHOD FOR PRODUCING SOLID CATALYST FOR PRETREATMENT DESULFURIZATION AND DESULFURIZATION METHOD USING SAME

(71) Applicant: Lowcarbon Co., Ltd, Gangjin-gun Jeollanam-do (KR)

(72) Inventors: Yong Jong SEO, Daejeon (KR); Jun Beam PARK, Daejeon (KR); Chang Taic OH, Mokpo-si Jeollanam-do (KR); A Ram PARK, Naju-si Jeollanam-do (KR); Cheol LEE, Cheongju-si Chungcheongbuk-do (KR); Chang Rae NO, Cheongju-si Chungcheongbuk-do (KR); Hong Ki CHOI, Muan-gun Jeollanam-do (KR); Wan Je KIM, Jangseong-gun, Jeollanam-do (KR); Jun Young LEE, Gangjin-gun Jeollanam-do (KR); Shin HAN, Gwangju (KR)

(73) Assignee: Lowcarbon Co., Ltd, Gangjin-gun Jeollanam-do (KR)

(21) Appl. No.: 19/127,064

(22) PCT Filed: Nov. 29, 2023
(86) PCT No.: PCT/KR2023/019460

§ 371 Date: May 2, 2025

(30) Foreign Application Priority Data
Nov. 29, 2022 (KR) 10-2022-0163221

(51) Int. Cl. B01J 37/02; B01J 23/78; B01J 27/188; B01J 37/00; C10L 1/12

(52) U.S. Cl. CPC B01J 37/0207; B01J 23/78; B01J 27/188; B01J 37/0036; B01J 37/0063; B01J 37/0236; C10L 1/1283

(57) ABSTRACT

A method for producing a solid catalyst for pretreatment desulfurization according to an embodiment of the present invention comprises the steps of: (a) preparing a liquid catalyst for pretreatment desulfurization; (b) pulverizing a porous structured carrier having pores to a predetermined size; (c) immersing the carrier pulverized to a predetermined size in step (b) in the liquid catalyst for pretreatment desulfurization prepared in step (a), followed by impregnation for 10 to 60 minutes; and (d) introducing the carrier into a drying machine while the liquid catalyst for pretreatment desulfurization has infiltrated into the pores of the carrier by impregnation in step (c), followed by drying at a temperature of 100° C. or higher for a predetermined time.

### TECHNICAL FIELD

The present disclosure relates to a method of producing a solid catalyst for pretreatment desulfurization and a desulfurization method using same. More specifically, the present disclosure relates to a method of producing a solid catalyst for pretreatment desulfurization, in which a liquid catalyst for pretreatment desulfurization is solidified by impregnating a carrier having pores with the liquid catalyst for pretreatment desulfurization and drying the resulting carrier, thus not only minimizing the weight of the catalyst for desulfurization but also simplifying production process equipment, and the solid catalyst for pretreatment desulfurization has improved storage stability and logistics costs, and to a desulfurization method using same.

### BACKGROUND ART

Sulfur oxides (SOx) and nitrogen oxides (NOx) are pointed out as pollutants causing air pollution. In particular, sulfur oxides are contained in industrial flue gas emitted due to the combustion of fossil fuels containing sulfur components, causing various types of environmental pollution, for example, leading to acid rain and the like, which is problematic.

Desulfurization methods to remove sulfur oxides from such industrial flue gas have continued to be studied. Additionally, in factories or power plants using fossil fuels, a flue gas desulfurization method, a post-combustion treatment method, has been typically used.

The flue gas desulfurization method refers to combusting sulfur gas-containing fossil fuel and subjecting the resulting flue gas to desulfurization. This flue gas desulfurization method can be divided into wet and dry methods. The wet method is to remove sulfur oxides by washing flue gas with ammonium water, a sodium hydroxide solution, lime milk, or the like, while the dry method is to remove sulfur oxides by making particles or powders of activated carbon, carbonate, or the like contact with flue gas and adsorbing or reacting sulfur dioxide.

However, desulfurization equipment for treating flue gas must be built separately to use such a flue gas desulfurization method. Additionally, there problems in that operating are the desulfurization equipment is labor-intensive and costly, and the desulfurization process is complex.

Therefore, to reduce sulfur oxide emissions associated with the combustion of fossil fuels, the situation is that there is an urgent need for research on a catalyst for pretreatment desulfurization that is pre-mixed with fuel before combusting the fuel, thus enabling desulfurization to occur at the same time in the combustion process of the fuel, and a desulfurization method.

One example of such a catalyst for pretreatment desulfurization is well-described in Korean Patent No. 1864999 (hereinafter referred to as a “pre-filed patent”) previously filed by the applicant of the present disclosure.

According to the pre-filed patent, a liquid catalyst for pretreatment desulfurization that is simple, easy to apply, and has an excellent desulfurization effect when a fossil fuel is combusted, a method of producing the catalyst for desulfurization, and a desulfurization method using the catalyst for desulfurization are disclosed.

However, the liquid catalyst for pretreatment desulfurization, described above, had the following problems.

First, the existing liquid catalyst for pretreatment desulfurization is prepared in a liquid form by mixing liquid raw materials, water, and the like. Accordingly, there were the following problems: complex production process equipment, poor storage safety due to the nature of liquid chemicals, and increased logistics and storage costs due to the need for transporting liquid forms using vehicles such as tank lorries equipped with special containers

Second, when admixing the existing liquid catalyst for pretreatment desulfurization with combustible materials, for example, coal, oil, or the like, for pretreatment, separate equipment is required for spraying. Accordingly, there was a problem with the increased burden of production process equipment costs.

Third, when adding a large amount of the existing liquid catalyst for pretreatment desulfurization, for example, to coal, the coal is formed into a gel. Accordingly, there was a problem in that a coal input port was blocked or a problem in that the catalyst in a slurry form oozed down in conjunction with the coal from a conveyor belt to return the coal.

For the above reasons, the situation is that there is an urgent need for developing and supplying solid catalysts for pretreatment desulfurization the weight of which is minimized by solidifying existing liquid catalysts pretreatment desulfurization into stable solid forms, the production process equipment of which is simplified, and the storage stability and logistics costs of which are improved.

### DISCLOSURE

### Technical Problem

Hence, the present disclosure, which has been devised to solve such problems described above, aims to provide a method of producing a solid catalyst for pretreatment desulfurization, in which a liquid catalyst for pretreatment desulfurization is solidified by impregnating a carrier having pores with the liquid catalyst for pretreatment desulfurization and drying the resulting carrier, thus not only minimizing the weight of the catalyst for desulfurization but also simplifying production process equipment, and the solid catalyst for pretreatment desulfurization has improved storage stability and logistics costs, and a desulfurization method using same.

### Technical Solution

To achieve such an objective described above, a method of producing a solid catalyst for pretreatment desulfurization of the present disclosure, according to one embodiment, is configured by including: Step (a) of preparing a liquid catalyst for pretreatment desulfurization; Step (b) of pulverizing a porous-structured carrier having pores to a predetermined size; Step (c) of immersing the carrier, pulverized to the predetermined size in Step (b), in the liquid catalyst for pretreatment desulfurization, prepared in Step (a), followed by impregnation for 10 to 60 minutes; and Step (d) of introducing the carrier into a drying machine while the liquid catalyst for pretreatment desulfurization has infiltrated into the pores of the carrier by the impregnation in Step (c), followed by drying at a temperature of 100° C. or higher for a predetermined time.

Additionally, according to one embodiment, the method further includes: Step (e) of pulverizing the dried carrier into a powder while the liquid catalyst for pretreatment desulfurization has infiltrated into the pores of the carrier, after Step (d).

Additionally, according to one embodiment, the method further includes: Step (f) of introducing the resulting solid, prepared as the powder through Step (e), into an extruder to produce a pellet or introducing the solid into a tableting machine to produce a tablet, after Step (e).

Additionally, according to one embodiment, the carrier in Step (b) includes at least one of vermiculite, perlite, diatomite, and activated carbon.

Additionally, according to one embodiment, in Step (c), the liquid catalyst for pretreatment desulfurization and the carrier are mixed at a mass ratio in a range of 5:1 to 20:1.

Additionally, according to one embodiment, Step (d) includes: a step of introducing the carrier into which the liquid catalyst for pretreatment desulfurization has infiltrated, into the drying machine and then heating the introduced carrier to a temperature of 230° C. from room temperature, followed by drying for 5 to 6 hours.

Additionally, according to one embodiment, Step (d) includes: Step (d-1) of introducing the carrier into which the liquid catalyst for pretreatment desulfurization has infiltrated, into the drying machine and then heating the introduced carrier to a temperature of 130° C. from room temperature, followed by primary drying for 2 hours; and Step (d-2) of heating the carrier, having undergone the primary drying in Step (d-1), to a temperature of 230° C., followed by secondary drying for 2 to 3 hours.

Additionally, according to one embodiment, the liquid catalyst for pretreatment desulfurization in Step (a) includes: an oxide including one or more selected from the group consisting of SiO₂, Al₂O₃, Fe₂O₃, TiO₂, MgO, MnO, CaO, Na₂O, K₂O, and P₂O₃; a metal including one or more selected from the group consisting of Li, Cr, Co, Ni, Cu, Zn, Ga, Sr, Cd, and Pb; and a liquid composition including one or more selected from the group consisting of sodium tetraborate (Na₂B₄O₇·10H₂O), sodium hydroxide (NaOH), sodium silicate (Na₂SiO₃), and hydrogen peroxide (H₂O₂).

Additionally, according to one embodiment, the oxide includes 15 to 90 parts by weight of SiO₂, 15 to 100 parts by weight of Al₂O₃, 10 to 50 parts by weight of Fe₂O₃, 5 to 15 parts by weight of TiO₂, 20 to 150 parts by weight of MgO, 10 to 20 parts by weight of MnO, 20 to 200 parts by weight of Cao, 15 to 45 parts by weight of Na₂O, 20 to 50 parts by weight of K₂O, and 5 to 20 parts by weight of P₂O₃.

Additionally, according to one embodiment, the metal includes 0.0035 to 0.009 parts by weight of Li, 0.005 to 0.01 parts by weight of Cr, 0.001 to 0.005 parts by weight of Co, 0.006 to 0.015 parts by weight of Ni, 0.018 to 0.03 parts by weight of Cu, 0.035 to 0.05 parts by weight of Zn, 0.04 to 0.08 parts by weight of Ga, 0.02 to 0.05 parts by weight of Sr, 0.002 to 0.01 parts by weight of Cd, and 0.003 to 0.005 parts by weight of Pb.

Additionally, according to one embodiment, the liquid composition includes 20 to 130 parts by weight of sodium tetraborate (Na₂B₄O₇·10H₂O), 15 to 120 parts by weight of sodium hydroxide (NaOH), 50 to 250 parts by weight of sodium silicate (Na₂SiO₃), and 10 to 50 parts by weight of hydrogen peroxide (H₂O₂).

In the meantime, a desulfurization method using the solid catalyst for pretreatment desulfurization of the present disclosure is characterized in that the solid catalyst for pretreatment desulfurization, produced as described above, is mixed with a combustible material and combusted, thereby adsorbing and removing a sulfur oxide.

Additionally, according to one embodiment, a ratio of the solid catalyst for pretreatment desulfurization mixed with the combustible material is controlled depending on a content ratio of C, H, N, and S contained in the combustible material.

### Advantageous Effects

As described above, a solid catalyst for pretreatment desulfurization produced by the present disclosure is solidified by impregnating a porous-structured carrier with a liquid catalyst for pretreatment desulfurization and drying the resulting carrier, thus not only minimizing the weight of the catalyst for desulfurization but also simplifying production process equipment. Additionally, the solid catalyst for pretreatment desulfurization has improved storage stability to moisture and logistics costs. Furthermore, the solid catalyst for pretreatment desulfurization is mixed with a combustible material through pretreatment to adsorb sulfur oxides (SOx) at high efficiency for removal. As a result, there is an effect of improving a desulfurization effect.

Additionally, the solid catalyst for pretreatment desulfurization, produced by the present disclosure, is adsorbed to ash generated from combustible particles in the process of combusting the combustible material, thus activating porosity, and reacts with sulfur oxides present in the ash for removal. As a result, there is an excellent effect of reducing sulfur oxide emissions before flue gas is generated.

Furthermore, the solid catalyst for pretreatment desulfurization, produced by the present disclosure, has excellent effects of not requiring investment in additional desulfurization facilities and being easily applicable regardless of the types of combustible material because the catalyst for desulfurization is mixed with the combustible material before combustion and then combusted, unlike existing methods in which flue gas is desulfurized after combusting fuels.

### DESCRIPTION OF DRAWINGS

FIG. 1 is a flow chart describing a method of producing a solid catalyst for pretreatment desulfurization of the present disclosure.

FIG. 2 shows photographic images illustrating step-by-step processes of supporting using vermiculite as a carrier and drying processes according to one embodiment of the present disclosure.

FIG. 3a is a graph showing primary drying experimental results of a carrier according to one embodiment of the present disclosure.

FIG. 3b is a graph showing secondary drying experimental results of a carrier according to one embodiment of the present disclosure.

FIG. 4a is a graph showing wetting test results of a solid catalyst using vermiculite as a carrier according to one embodiment of the present disclosure.

FIG. 4b shows photographic images illustrating wetting states of the solid catalyst in FIG. 4a over time.

### BEST MODE

Terms used herein are merely for describing specific embodiments and are not intended to limit the present disclosure. The singular expressions include the plural expressions unless the context clearly indicates otherwise. It will be further understood that the terms “comprises,” “includes,” “has,” “provides,” and the like used herein specify the presence of features, integers, steps, operations, elements, components, or combinations thereof stated herein, but do not preclude the presence or addition of one or more other features, integers, steps, operations, elements, components, or combinations thereof.

Unless otherwise defined, all terms used herein, including technical or scientific terms, have the same meaning as commonly understood by those skilled in the art to which the present disclosure pertains.

Terms, such as those defined in commonly used dictionaries, should be interpreted as having a meaning that is consistent with their meaning in the context of the related art and should not be interpreted in an idealized or overly formal sense unless expressly so defined herein.

Hereinafter, for a detailed description with reference to the accompanying drawings, a method of producing a solid catalyst for pretreatment desulfurization, according to one embodiment of the present disclosure, is as follows.

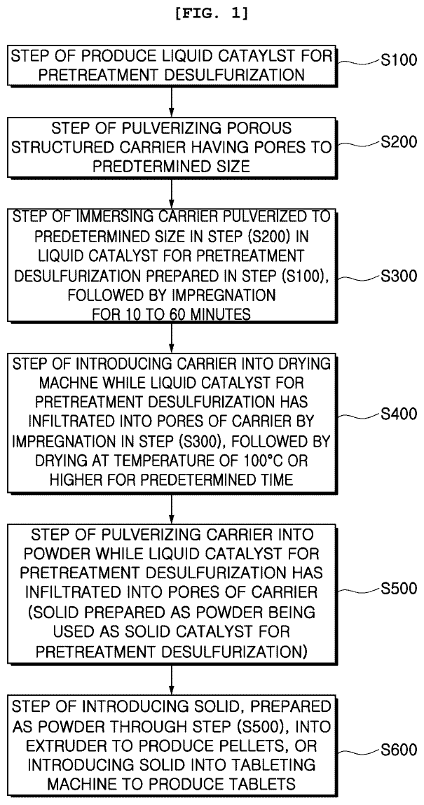

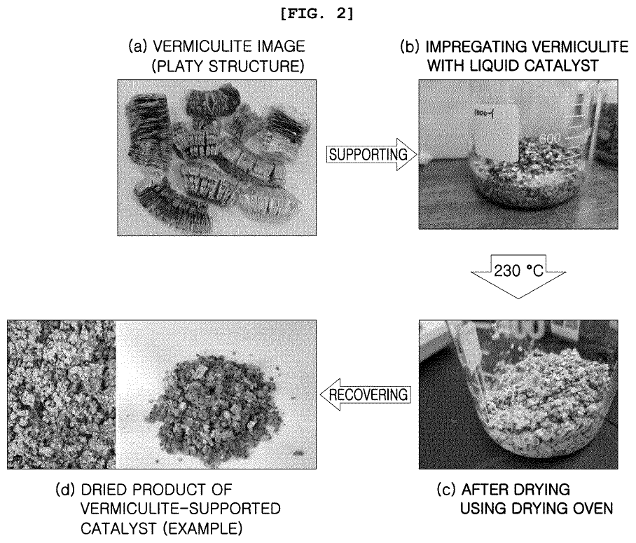

FIG. 1 is a flow chart describing the method of producing a solid catalyst for pretreatment desulfurization of the present disclosure, and FIG. 2 shows photographic images illustrating step-by-step processes of supporting using vermiculite as a carrier and drying processes according to one embodiment of the present disclosure.

First, for a description according to one embodiment of the present disclosure, the method of producing a solid catalyst for pretreatment desulfurization of the present disclosure may be composed of the following steps according to one embodiment.

Step (a): A liquid catalyst for pretreatment desulfurization is prepared (S100).

The liquid catalyst for pretreatment desulfurization, according to the present disclosure, may be prepared by the following detailed steps according to one embodiment.

Step (a-1): An oxide powder including one or more selected from the group consisting of SiO₂, Al₂O₃, Fe₂O₃, TiO₂, MgO, MnO, Cao, Na₂O, K₂O, and P₂O₃ is mixed and ground.

Step (a-2): A metal powder including one or more selected from the group consisting of Li, Cr, Co, Ni, Cu, Zn, Ga, Sr, Cd, and Pb is mixed and ground.

Step (a-3): The oxide in Step (a-1) and the metal in Step (a-2) are mixed with a liquid composition including one or more selected from the group consisting of sodium tetraborate (Na₂B₄O₇·10H₂O), sodium hydroxide (NaOH), sodium silicate (Na₂SiO₃), and hydrogen peroxide (H₂O₂) to form a catalyst for desulfurization.

Step (a-1) is to mix the oxide powder including one or more selected from the group consisting of SiO₂, Al₂O₃, Fe₂O₃, TiO₂, MgO, MnO, Cao, Na₂O, K₂O, and P₂O₃, followed by grinding using a grinder.

In this step, the oxide powder may include 15 to 90 parts by weight of SiO₂, 15 to 100 parts by weight of Al₂O₃, 10 to 50 parts by weight of Fe₂O₃, 5 to 15 parts by weight of TiO₂, 20 to 150 parts by weight of MgO, 10 to 20 parts by weight of MnO, 20 to 200 parts by weight of Cao, 15 to 45 parts by weight of Na₂O, 20 to 50 parts by weight of K₂O, and 5 to 20 parts by weight of P₂O₃.

Additionally, the oxide powder ground in this step may be repeatedly subjected to grinding so that the particle size thereof is ground to be in the range of 1 to 2 μm.

Step (a-2) is to mix the metal powder including one or more selected from the group consisting of Li, Cr, Co, Ni, Cu, Zn, Ga, Sr, Cd, and Pb, followed by grinding using a grinder.

In this step, the metal powder may include 0.0035 to 0.009 parts by weight of Li, 0.005 to 0.01 parts by weight of Cr, 0.001 to 0.005 parts by weight of Co, 0.006 to 0.015 parts by weight of Ni, 0.018 to 0.03 parts by weight of Cu, 0.035 to 0.05 parts by weight of Zn, 0.04 to 0.08 parts by weight of Ga, 0.02 to 0.05 parts by weight of Sr, 0.002 to 0.01 parts by weight of Cd, and 0.003 to 0.005 parts by weight of Pb.

Additionally, the metal powder ground in this step may be repeatedly subjected to grinding so that the particle size thereof is ground to be in the range of 1 to 2 μm.

In Step (a-3), the oxide powder and the metal powder, mixed and ground in Steps (a-1) and (a-2), respectively, are mixed with the liquid composition including one or more selected from the group consisting of sodium tetraborate (Na₂B₄O₇·10H₂O), sodium hydroxide (NaOH), sodium silicate (Na₂SiO₃), and hydrogen peroxide (H₂O₂) to form the liquid catalyst for pretreatment desulfurization.

In this step, the liquid composition may include 20 to 130 parts by weight of sodium tetraborate (Na₂B₄O₇·10H₂O), 15 to 120 parts by weight of sodium hydroxide (NaOH), 50 to 250 parts by weight of sodium silicate (Na₂SiO₃), and 10 to 50 parts by weight of hydrogen peroxide (H₂O₂).

Additionally, in this step, when the oxide powder and the metal powder, mixed and ground in Steps (a-1) and (a-2), respectively, are mixed and react with the liquid composition, the oxide powder and the liquid composition may serve as a chelating agent and thus chelate with the metal powder. As a result, a metal chelate compound may be formed.

Additionally, the liquid catalyst for pretreatment desulfurization formed in this step is stabilized by precipitation for 24 to 72 hours. The precipitated catalyst for desulfurization may be separated and naturally dried for use as a powder catalyst for desulfurization that is powdered. Furthermore, the liquid-form composition remaining without the precipitated catalyst for desulfurization, which has been separated, may be used as the liquid catalyst for pretreatment desulfurization of the present disclosure.

In this case, the precipitate of the precipitated liquid catalyst for desulfurization is naturally dried and named the powder catalyst (GTS-P) for desulfurization, and the liquid composition from which the precipitated powder composition has been separated is transferred to a separate container and named the liquid catalyst (GTS) for pretreatment desulfurization.

For reference, the powder catalyst (GTS-P) for desulfurization can be obtained by naturally drying the precipitate of the liquid catalyst (GTS) for pretreatment desulfurization for solidification, as described above. However, in this case, several problems occurred as follows.

First, GTS-P is highly viscous. For this reason, not only the drying speed thereof was extremely slow, but also difficulties arose in internal drying due to the solidification of surface areas. Hence, when raising the drying temperature to dry GTS in an aqueous solution form, GTS was highly soluble in water and thus existed as a highly viscous liquid, resulting in complexity in the production.

Second, after drying, the metal equipment was corroded, and there was a problem with the resulting GTS deposits on the walls of the equipment. Additionally, during storage under normal atmospheric conditions, the storage safety was poor due to moisture absorption. Furthermore, the powder solid of GTS-P obtained by simple drying absorbed moisture in the air when dispersed in coal and thus was rapidly liquified, resulting in complexity in the addition method and equipment. For the above reasons, the powder catalyst (GTS-P) for desulfurization was unsuitable for use as the solid catalyst for pretreatment desulfurization of the present disclosure.

Therefore, the production and preparation of the liquid catalyst (GTS) for pretreatment desulfurization, one of the main materials in the present disclosure, is completed through Steps (a-1) to (a-3) described above.

Step (b): A porous-structured carrier having pores is pulverized to a predetermined size (S200).

According to one embodiment, carriers such as expanded vermiculite, pearlite, diatomite, or activated carbon, which are porous materials, were used as the carrier. The carrier used had an apparent specific gravity in the range of 0.1 to 0.5, an absorption rate in the range of 60 to 300 cc/100 g, and a particle size in the range of 10 to 2,000 μm.

The carrier is preferably a porous-structured material. Numerous pores within the carrier have moisture retention capacity and thus may appropriately contain a desulfurizing component as a solid. Additionally, the carrier is air-permeable, thus producing sodium sulfate (Na₂SO₄) through a reaction with sulfur oxides, and in particular, has heat-insulating properties, thus inhibiting decomposition reactions in high-temperature ranges. Typically, temperatures of 1200° C. or higher cause decomposition reactions and decompose sodium sulfate into sulfur oxides, which may be emitted as flue gas. As a result, a problem with poor desulfurization performance may occur. Furthermore, the desulfurizing component, which is strongly alkaline, exists within the porous material and acts as a steric hindrance capable of minimizing the attachment of the strong alkaline component to the inner wall of a combustion furnace. Accordingly, high-temperature corrosion caused by the attachment of alkali to the inner wall of the combustion furnace may be avoided. In particular, expanded vermiculite having a platy structure has a faster moisture absorption speed and thus is advantageous in terms of liquid-solid impregnation.

Step (c): The carrier, pulverized to the predetermined size in Step (b), is immersed in the liquid catalyst for pretreatment desulfurization, prepared in Step (a), followed by impregnation for 10 to 60 minutes (S300).

According to one embodiment, the liquid catalyst (GTS) for pretreatment desulfurization and the vermiculite carrier may be mixed at a mass ratio in the range of 5:1 to 20:1 and are more preferably mixed to have a mass ratio of 10:1.

In terms of the time for which the vermiculite carrier is impregnated with the liquid catalyst (GTS) for pretreatment desulfurization, the impregnation is performed for at least 1 hour so that the pores of the vermiculite carrier can be impregnated sufficiently with the liquid catalyst for pretreatment desulfurization.

Step (d): The carrier is introduced into a drying machine while the liquid catalyst for pretreatment desulfurization has infiltrated into the pores of the carrier by the impregnation in Step (c), followed by drying at a temperature of 100° C. or higher for a predetermined time (S400).

In this case, the carrier into which the liquid catalyst for pretreatment desulfurization has infiltrated is introduced into the drying machine and heated to raise the temperature inside the drying machine to 230° C. from room temperature, followed by drying for 5 to 6 hours.

Additionally, Step (d) may be composed of the following detailed steps according to one embodiment.

Step (d-1): The carrier into which the liquid catalyst for pretreatment desulfurization has infiltrated is introduced into the drying machine and then heated to raise the temperature inside the drying machine to 130° C. from room temperature, followed by primary drying for 2 hours.

Step (d-2): The carrier, having undergone the primary drying in Step (d-1), is heated to a temperature of 230° C., followed by secondary drying for 2 to 3 hours.

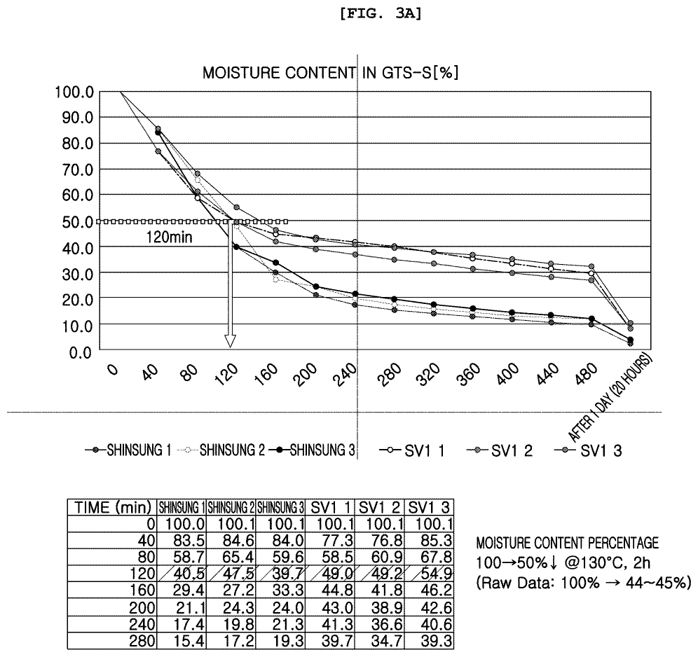

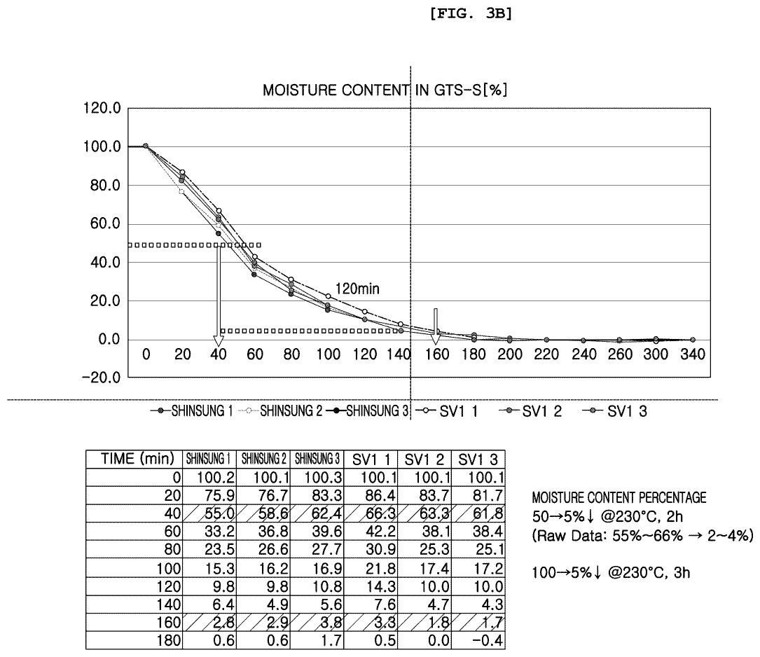

Through the primary drying, in which the carrier is heated to a temperature of 130° C. from room temperature and then dried, and the secondary drying, in which the carrier is heated to a temperature of 230° C. from 130° C. and then dried, the drying is performed in a multi-step manner for a sufficient drying time as described above. As a result, the heat evenly penetrated even inside the porous structure, confirming that the carrier was evenly dried. Additionally, it was confirmed in the drying experiment to be described below that the moisture content percentage of the carrier into which the liquid catalyst for pretreatment desulfurization had infiltrated reached less than 5% in the resulting product that had undergone both the primary drying and the secondary drying (see FIGS. 3a and 3b).

In the meantime, even when only the secondary drying in Step (d-2) is performed for 160 minutes according to another embodiment without undergoing both processes of the primary drying and the secondary drying in Steps (d-1) and (d-2), respectively, like one embodiment described above, the moisture content percentage of less than 5% is reachable (see the bottom table in FIG. 3b).

Additionally, in the embodiments described above, the carrier is dried while undergoing rolling motion inside a drum-type drying container when a drum-type powder drying machine is used as the drying machine. Thus, the drying time may be much shortened, which is much more advantageous in continuously producing the solid catalyst for pretreatment desulfurization, according to the present disclosure.

Step (e): After being dried while the liquid catalyst for pretreatment desulfurization has infiltrated into the pores of the carrier, the carrier is put into a pulverizer and then pulverized to a predetermined size (S500).

In terms of the pulverized size, the resulting solid may be pulverized to a particle size of 10 meshes (1.9 mm) or smaller using the pulverizer, but may be pulverized to a proper size depending on the types of combustible material and mixing methods. Therefore, such a powdered solid prepared may be used immediately as the solid catalyst for pretreatment desulfurization (first type) of the present disclosure.

Step (f): The resulting solid, prepared as the powder through Step (e), is introduced into an extruder to produce a pellet (second type), or the solid is introduced into a tableting machine to produce a tablet (third type) (S600).

As described above, the production of the solid catalyst for pretreatment desulfurization (hereinafter referred to as “GTS-S”) of the present disclosure, which is processed as the powder (first type), the pellet (second type), or the tablet (third type) through Steps (a) to (f) described above, is finally completed.

In other words, the dried product prepared as the powder may be shipped as a GTS-S product, processed as a pellet form using the extruder, processed as the tablet using the tableting machine after pulverizing the solid to a particle size of 10 meshes (1.9 mm) or smaller using the pulverizer, or processed otherwise to produce various types of GTS-S products. In this case, the size of the pellet or tablet, produced as described above according to one embodiment, is in the range of 2 mm to 50 mm in diameter, and the length-to-diameter ratio (L/D) thereof produced may be a size of 1 or less.

### <Experimental Example 1>Drying Experiment of Vermiculite-Supported Solid Catalyst (GTS-S) for Pretreatment Desulfurization

Hereinbelow, referring to FIGS. 3a and 3b, the present disclosure is to be described in more detail with reference to drying experimental results using a vermiculite carrier. However, the experimental results presented are only specific examples of the present disclosure and are not intended to limit the scope of the present disclosure.

FIG. 3a is a graph showing primary drying experimental results of the solid catalyst for pretreatment desulfurization according to one embodiment of the present disclosure.

### Primary Drying Experimental Results of GTS-S at 130° C.

GTS-S was introduced into a drying machine and then heated to raise the temperature to 130° C. from room temperature, followed by drying while measuring the moisture content percentage at regular intervals.

The moisture content percentage was measured every 40 minutes after raising the temperature to 130° C. from room temperature. As a result, all Samples 1 to 6 (Shinsung 1, 2, and 3 and SV1 1, 2, and 3) exhibited moisture content percentages of less than 50% from a point in time that 120 minutes had elapsed, confirming that the target value for the primary drying was met (see the bottom table regarding moisture content percentage in FIG. 3a).

Specifically, changes in the moisture ratio caused by weight loss were measured using a thermogravimetric analyzer (TGA, model name: TGA Q500) under an N2 condition at a temperature in the range of 40° C. to 150° C. (10° C./min).

Here, in the graph of FIG. 3a, Shinsung 1, 2, and 3 refer to samples using No. 2 Vermiculite from Shinsung Mineral, and SV1 1, 2, and 3 refer to samples using SV1 Vermiculite from Kwangwoo.

In other words, although there were some differences in components and absorption rates between Shinsung 1, 2, and 3 and SV1 1, 2, and 3 due to different origins, three identical samples from the respective manufacturers were prepared for the measurement of weight changes to verify reproducibility using the samples that are all the same in mass.

FIG. 3b is a graph showing secondary drying experimental results of the solid catalyst for pretreatment desulfurization according to one embodiment of the present disclosure.

### Secondary Drying Experimental Results of GTS-S at 230° C.

In secondary drying, accelerated drying (rapid drying) was performed at 230° C., which is a temperature higher than that described above of the primary drying in FIG. 3a.

The moisture content percentage was measured every 20 minutes after raising the temperature to 230° C. from 130° C. As a result, it was found that the moisture content percentages of all Samples 1 to 6 (Shinsung 1, 2, and 3 SV1 1, 2, and 3) were less than 5% from a point in time that 160 minutes had elapsed, confirming that the final target value of the moisture content percentage (less than 5%) for the drying was met.

Specifically, changes in the moisture ratio caused by weight loss were measured using a TGA (model name: TGA Q500) under an N2 condition at a temperature in the range of 40° C. to 150° C. (10° C./min).

In other words, the moisture content percentage reached less than 50%, the target value for the primary drying, as 60 minutes elapsed in the secondary drying, and the moisture content percentage reached less than 58, the final target value, after 160 minutes, confirming that it took about an additional 100 minutes from the point in time at which the primary drying was completed to at which the secondary drying was finally completed (see the bottom table regarding moisture content percentage in FIG. 3b).

Here, in the graph of FIG. 3b, Shinsung 1, 2, and 3 refer to samples using No. 2 Vermiculite from Shinsung Mineral, and SV1 1, 2, and 3 refer to samples using SV1 Vermiculite from Kwangwoo.

Additionally, as shown in FIG. 3a, three identical samples from the respective manufacturers were prepared for the measurement of weight changes to verify reproducibility using the samples that are all the same in mass.

### <Experimental Example 2>Wetting Test of Vermiculite-Supported Solid Catalyst (GTS-S) for Pretreatment Desulfurization

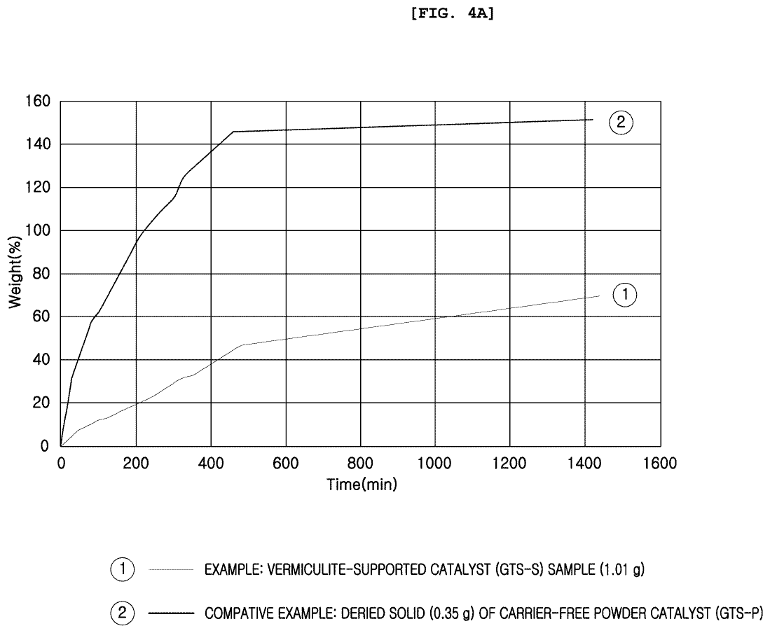

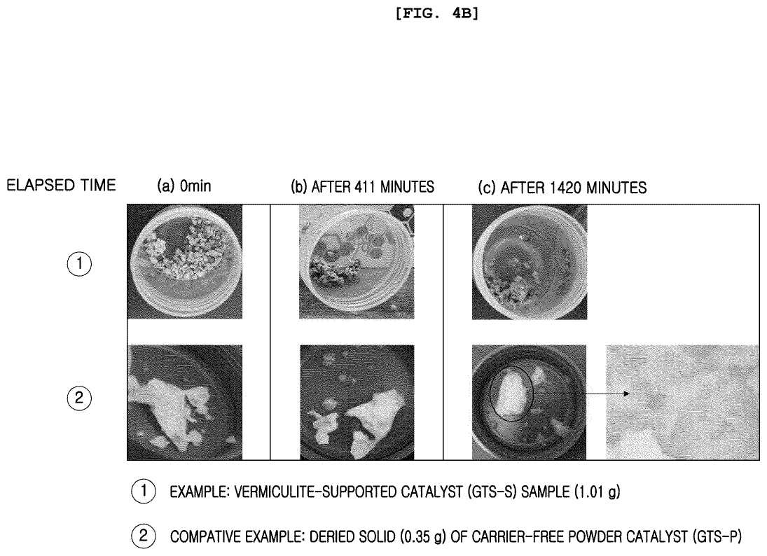

Hereinbelow, referring to FIGS. 4a and 4b, the present disclosure is to be described in more detail with reference to wetting test results using a vermiculite carrier. However, the test results presented are only specific examples of the present disclosure and are not intended to limit the scope of the present disclosure.

FIG. 4a is a graph showing wetting test results of the solid catalyst using vermiculite as the carrier according to one embodiment of the present disclosure, and FIG. 4b shows photographic images illustrating wetting states of the solid catalyst in FIG. 4a over time.

Referring to FIG. 4a, a final GTS-S product, produced according to the present disclosure, was left exposed to the atmosphere to measure changes in the increase of absorbed moisture weight percent (%) at regular intervals.

In this test, a sample of an example used was 1.01 g of the solid catalyst (GTS-S) for pretreatment desulfurization using the vermiculite carrier, produced according to the present disclosure, and a sample of a comparative example used was 0.35 g of a carrier-free powder catalyst (GTS-P).

The moisture weight percent (%) by sample, that is, the moisture absorption amount, may be calculated as follows.

$$Moisture absorption amount ( \% ) = ( weight of final GTS - S product after being exposed to air - weight of final GTS - S product ) \text{} / ( weight of final GTS - S product ) * 100 \%$$

As a result of the measurement, a pattern where the moisture weight percent (moisture absorption amount) was rapidly increased was observed in both samples of the example and the comparative example after 400 minutes had elapsed, until a predetermined point in time between 400 and 500 minutes.

In particular, the moisture weight percent of the sample of the comparative example rapidly increased three times or more than that of the sample of the example. Referring to FIG. 4b, due to the rapidly increased moisture (b) after 411 minutes elapsed and (c) after 1420 minutes elapsed, several problems, including attachment to the walls, aggregation, and conversion into aqueous solution forms, were observed in the dried solid of the carrier-free powder catalyst (GTS-P) of the comparative example.

Therefore, it was confirmed that the sample of the example exhibited much better wetting stability in terms of moisture absorption over time than the sample of the comparative example.

### <Experimental Example 3>Desulfurization Performance Test Results of Vermiculite-Supported Solid (GTS-S) for Catalyst Pretreatment Desulfurization Using Sulfur Analyzer

TABLE 1

| | | Supported ratio | Detected | Reduced | Reduced |
|---|---|---|---|---|---|
| | | (GTS/vermiculite | amount of S | amount of S | rate of S |
| No | Sample name | weight ratio) | (%) | (%) | (%) |
| 1 | Comparative | — | 0.02 | 0.24 | 92.31 |
| | Example (GTS-P) | | | | |
| 2 | Example 1 (GTS-S) | 10.8 | 0.02 | 0.24 | 92.31 |
| 3 | Example 2 (GTS-S) | 14.6 | 0.03 | 0.23 | 88.46 |
| 4 | Example 3 (GTS-S) | 19.8 | 0.03 | 0.23 | 88.46 |
| 5 | Example 4 (GTS-S) | 19.8 | 0.05 | 0.21 | 80.77 |
| 6 | Example 5 (GTS-S) | 9.7 | 0.02 | 0.24 | 92.31 |

As can be seen from Table 1, the table showing desulfurization performance test results, it was confirmed that, compared to the carrier-free powder catalyst for desulfurization of the comparative example, the solid catalysts for pretreatment desulfurization of the present disclosure in Examples 1 to 5, exhibiting wetting stability, showed the same or equivalent level of performance in terms of the detected amount, reduced amount, and reduced rate of S (sulfur).

Specifically, in this desulfurization performance test, 1 to 3 g of the liquid catalyst (GTS) for pretreatment desulfurization was mixed with 10 g of ground coal and then dried, followed by weighing 45 to 45 mg of the resulting coal sample in a crucible and measuring the desulfurization performance at a temperature of 1150° C. for approximately 5 minutes using CKiC (model name “5E-AS3200B”), a sulfur analyzer.

In particular, even though the feeding amount of the liquid catalyst (GTS) for pretreatment desulfurization was the smallest, Example 5 was confirmed to be the most advantageous in terms of cost-effectiveness because the same level of desulfurization performance as that in the case of comparative example was shown.

In the meantime, a desulfurization method using the solid catalyst for pretreatment desulfurization of the present disclosure is characterized in that the solid catalyst for pretreatment desulfurization, produced as described above, is pre-mixed with a combustible material and then combusted, thus adsorbing and removing sulfur oxides through pretreatment in the combustion process.

Additionally, according to one embodiment, the mixing ratio of the solid catalyst for pretreatment desulfurization mixed with the combustible material may be controlled depending on the content ratio of C, H, N, and S contained in the combustible material. For example, when the combustible material is coal from Uong Bi 3, Vietnam, the sulfur content is high. Thus, the solid catalyst (GTS-S) for pretreatment desulfurization of the present disclosure needs to be mixed more by increasing the feeding amount thereof compared to typical coal.

### <Method of Calculating Added Amount of Solidified GTS-S (Gs) to Coal>

The following formula is for calculating the feeding amount of the solid catalyst (GTS-S) for pretreatment desulfurization according to the present disclosure.

$$f ( factor ) = G 1 / Gs \qquad [ Formula 1 ]$$

(where f is the mass ratio of a solution of the liquid catalyst, GTS, contained in the solid catalyst, GTS-S, Gl is the mass of the liquid catalyst, GTS, and Gs is the mass of the solid catalyst, GTS-S)

When the weight of dried Gs into which 100 g of Gl is supported is 35 g,

$$f = 100 g / 35 g = 2.85$$

From [Formula 1] above, Gs=Gl/f was derived.

Therefore, when GTS is converted from GTS-S and required to be added in 12 g,

$$Gs = G 1 / f = 12 g / 2.85 = 4.21 g$$

Thus, only 4.21 g (35%) of the solid catalyst (GTS-S) for pretreatment desulfurization of the present disclosure needs to be fed in terms of the weight, so a weight reduction effect of 65% compared to 12 g of the existing liquid catalyst (GTS) for pretreatment desulfurization, required to be fed to obtain the same level of the desulfurization effect, is achievable.

Additionally, in the desulfurization method using the catalyst for desulfurization, according to the present disclosure, the solid catalyst for pretreatment desulfurization is mixed in conjunction with the combustible material before combusting the combustible material and then combusted, thus activating the desulfurization function in the combustion process and enabling sulfur oxides in the flue gas to be removed in advance.

In other words, despite being methods of removing sulfur oxides (SOx) contained in flue gas generated after combusting combustible materials alone, existing flue gas desulfurization methods not only require desulfurization equipment to perform such processes but also are labor-intensive and costly to operate the equipment, which is disadvantageous. However, in the desulfurization method using the solid catalyst for pretreatment desulfurization, according to the present disclosure, the catalyst for desulfurization is pre-mixed with the combustible material before combusting the combustible material and then combusted in conjunction, thus enabling the catalyst for desulfurization to adsorb and remove sulfur oxides generated with the combustion of the combustible material in the combustion process. As a result, an excellent desulfurization effect of reducing sulfur oxide emission from flue gas can be shown.

Additionally, as the combustible material to which the catalyst for desulfurization of the present disclosure is applicable, combustible materials, such as coal, oil, waste, biogas, and the like, that generate heat through combustion may be used. However, the catalyst for desulfurization is preferably applicable to coal.

Additionally, the solid catalyst for pretreatment desulfurization, described above, is admixed at a predetermined ratio before combusting the combustible material and then combusted in conjunction with the combustible material. However, in this case, the admixing amount of the solid catalyst for pretreatment desulfurization may be controlled depending on the contents of C, H, N, and S contained in the combustible material, thus maintaining the excellent desulfurization effect.

Furthermore, the present disclosure is not merely limited to one embodiment described above, and the same effect can be made even when the detailed configuration, number, and arrangement of the system are changed. Accordingly, those skilled in the art will appreciate that various additions, deletions, and modifications of various configurations are possible within the scope of the technical spirit of the present disclosure.

### INDUSTRIAL APPLICABILITY

The present disclosure can be used extensively in the fields of a method of producing a solid catalyst for pretreatment desulfurization and a desulfurization method using same.

1. A method of producing a solid catalyst for pretreatment desulfurization, the method comprising:
(a) preparing a liquid catalyst for pretreatment desulfurization;
(b) pulverizing a porous-structured carrier having pores to a predetermined size;
(c) immersing the carrier, pulverized to the predetermined size in the (b) pulverizing, in the liquid catalyst, prepared in the (a) preparing, followed by impregnation for 10 to 60 minutes; and
(d) introducing the carrier into a drying machine while the liquid catalyst has infiltrated into the pores of the carrier by the impregnation in the (c) immersing, followed by drying at a temperature of 100° C. or higher for a predetermined time.

2. The method of claim 1, further comprising:
(e) pulverizing the dried carrier into a powder while the liquid catalyst has infiltrated into the pores of the carrier, after the (d) introducing.

3. The method of claim 2, further comprising:
(f) using the resulting solid, prepared as the powder through the (e) pulverizing, as the solid catalyst, introducing the solid into an extruder to produce a pellet, or introducing the solid into a tableting machine to produce a tablet, after the (e) pulverizing.

4. The method of claim 1, wherein the carrier in the (b) pulverizing comprises at least one of vermiculite, perlite, diatomite, and activated carbon.

5. The method of claim 1, wherein in the (c) immersing, the liquid catalyst and the carrier are mixed at a mass ratio in a range of 5:1 to 20:1.

6. The method of claim 1, wherein the (d) introducing comprises:
introducing the carrier into which the liquid catalyst has infiltrated, into the drying machine and then heating the introduced carrier to a temperature of 230° C. from room temperature, followed by drying for 5 to 6 hours.

7. The method of claim 1, wherein the (d) introducing comprises:
(d-1) introducing the carrier into which the liquid catalyst has infiltrated, into the drying machine and then heating the introduced carrier to a temperature of 130° C. from room temperature, followed by primary drying for 2 hours; and
(d-2) heating the carrier, having undergone the primary drying in the (d-1) introducing, to a temperature of 230° C., followed by secondary drying for 2 to 3 hours.

8. The method of claim 1, wherein the liquid catalyst in the (a) preparing comprises:
an oxide comprising one or more selected from the group consisting of SiO₂, Al₂O₃, Fe₂O₃, TiO₂, MgO, MnO, Cao, Na₂O, K₂O, and P₂O₃;
a metal comprising one or more selected from the group consisting of Li, Cr, Co, Ni, Cu, Zn, Ga, Sr, Cd, and Pb; and
a liquid composition comprising one or more selected from the group consisting of sodium tetraborate (Na₂B₄O₇·10H₂O), sodium hydroxide (NaOH), sodium silicate (Na₂SiO₃), and hydrogen peroxide (H₂O₂).

9. The method of claim 8, wherein the oxide comprises 15 to 90 parts by weight of SiO₂, 15 to 100 parts by weight of Al₂O₃, 10 to 50 parts by weight of Fe₂O₃, 5 to 15 parts by weight of TiO₂, 20 to 150 parts by weight of MgO, 10 to 20 parts by weight of MnO, 20 to 200 parts by weight of Cao, 15 to 45 parts by weight of Na₂O, 20 to 50 parts by weight of K₂O, and 5 to 20 parts by weight of P₂O₃.

10. The method of claim 8, wherein the metal comprises 0.0035 to 0.009 parts by weight of Li, 0.005 to 0.01 parts by weight of Cr, 0.001 to 0.005 parts by weight of Co, 0.006 to 0.015 parts by weight of Ni, 0.018 to 0.03 parts by weight of Cu, 0.035 to 0.05 parts by weight of Zn, 0.04 to 0.08 parts by weight of Ga, 0.02 to 0.05 parts by weight of Sr, 0.002 to 0.01 parts by weight of Cd, and 0.003 to 0.005 parts by weight of Pb.

11. The method of claim 8, wherein the liquid of sodium composition comprises 20 to 130 parts by weight tetraborate (Na₂B₄O_{7·}10H₂O), 15 to 120 parts by weight of sodium hydroxide (NaOH), 50 to 250 parts by weight of sodium silicate (Na₂SiO₃), and 10 to 50 parts by weight of hydrogen peroxide (H₂O₂).

12. A desulfurization method using a solid catalyst for pretreatment desulfurization, the desulfurization method enabling the solid catalyst being the solid catalyst produced by the method of any one of claims 1 to 11 to be mixed with a combustible material and combusted, thereby adsorbing and removing a sulfur oxide.

13. The desulfurization method of claim 12, wherein a ratio of the solid catalyst mixed with the combustible material is controlled depending on a content ratio of C, H, N, and S contained in the combustible material.
